(19) United States
(12) Patent Application Publication
(10) Pub. No.: US 2023/0348781 A1
(43) Pub. Date: Nov. 2, 2023

(54) FLUORESCENT PROBE FOR DETECTION OF JASMONIC ACID (JA) AND PREPARATION METHOD THEREOF, AND DETECTION METHOD OF JA

(71) Applicant: Zhejiang University, Hangzhou City (CN)

(72) Inventors: Yong HE, Hangzhou City (CN); Yongqiang Shi, Hangzhou City (CN); Xuping Feng, Hangzhou City (CN); Dandan Kong, Hangzhou City (CN); Fangfang Qu, Hangzhou City (CN); Yahui Zhang, Hangzhou City (CN)

(21) Appl. No.: 18/149,866

(22) Filed: Jan. 4, 2023

(30) Foreign Application Priority Data
Apr. 29, 2022 (CN) 202210474606.3

(51) Int. Cl. C09K 11/65; G01N 21/64

(52) U.S. Cl. CPC C09K 11/65; G01N 21/6428; G01N 2021/6439

(57) ABSTRACT

The present disclosure provides a fluorescent probe for detection of jasmonic acid (JA) and a preparation method thereof, and a detection method of JA, belonging to the technical field of component detection, The fluorescent probe for detection of JA includes a cobalt-based metal-organic framework (MOF) material, and aminated carbon quantum dots (CQDs) and a molecular imprinting polymer (MIP) that are distributed on a surface of the Co-MOF material; where the MIP has a molecular imprinting (MI) of the JA. In the present disclosure, the NCQDs are distributed on the surface of the Co-MOF material, and cobalt ions can undergo a coordination reaction with amino groups to change a charge distribution on a surface of the NCQD; meanwhile, the Co-MOF material can also avoid aggregation of the NCQDs to improve a detection stability.

### CROSS-REFERENCE TO RELATED APPLICATION

This patent application claims the benefit and priority of Chinese Patent Application No. 202210474606.3, filed with the China National Intellectual Property Administration on Apr. 29, 2022, the disclosure of which is incorporated by reference herein in its entirety as part of the present application.

### TECHNICAL FIELD

The present disclosure relates to the technical field of component detection, in particular to a fluorescent probe for detection of jasmonic acid (JA) and a preparation method thereof, and a detection method of JA.

### BACKGROUND

Jasmonic acid (JA) is an important plant hormone that plays a pivotal role in regulating crop growth and development, resisting fungal and bacterial infections, and enhancing environmental tolerance to various biotic and abiotic stresses. Rapid and sensitive determination of JA is essential to reveal its regulatory mechanism in crops. Traditional methods for the detection of JA include enzyme-linked immunosorbent assay (ELISA), gas chromatography-mass spectrometry (GC-MS), high-performance liquid chromatography (HPLC), and capillary electrophoresis using laser-induced fluorescence (CE-LIF). However, these methods generally require expensive instruments, or rely on skilled technicians, or have a time-consuming and labor-intensive detection process, making them incapable of adapting to the rapid development of crop phenotyping researches.

Fluorescence analysis has attracted increasing attention of researchers due to high sensitivity, fast response, and simple operation. Researchers have reported use of fluorescent probes in detecting plant hormones or biomarkers in crops, including ethylene, salicylic acid, 1-naphthylacetic acid, and indole-3-butyric acid. Among various fluorescent materials, carbon quantum dots (CQDs) have excellent photoluminescence properties and tunable emission peak positions. Studies have shown that CQDs synthesized through a certain strategy have dual emission or even multiple emission characteristics, making the CQDs expected to be an ideal fluorescent material that can replace traditional systems for the construction of ratiometric probes.

However, non-functionalized CQDs have disadvantages such as easy aggregation and poor stability, with their sensitivity and specificity to be enhanced when applied to JA detection.

### SUMMARY

In view of this, an objective of the present disclosure is to provide a fluorescent probe for detection of JA and a preparation method thereof, and a detection method of JA. The fluorescent probe for detection of JA has a desirable stability and can realize sensitive and specific detection of the JA.

To achieve the above objective, the present disclosure provides the following technical solutions.

The present disclosure provides a fluorescent probe for detection of JA, including a cobalt-based metal-organic framework (Co-MOF) material, and aminated carbon quantum dots (NCQDs) and a molecular imprinting polymer (MIP) that are distributed on a surface of the Co-MOF material; where the MIP has a molecular imprinting (MI) of the JA.

Preferably, the MIP has a functional monomer of (3-aminopropyl)triethoxysilane (APTES); and

the Co-MOF material has an organic ligand of 2,4-dimethylimidazole.

Preferably, the Co-MOF material and the MIP have a mass ratio of (1,000-6,000):1.

Preferably, the fluorescent probe for detection of JA has a particle size of 100 nm to 500 nm; and the MIP has a thickness of 3 nm to 20 nm.

The present disclosure further provides a preparation method of the fluorescent probe for detection of JA, including the following steps:
(1) providing the NCQDs and the Co-MOF material;
(2) mixing the NCQDs and the Co-MOF material with water to obtain an NCQDs-loaded Co-MOF material; and
(3) mixing the NCQDs-loaded Co-MOF material with a JA template, the functional monomer, a cross-linking agent, and an alkaline reagent, conducting polymerization, and removing the JA template to obtain the fluorescent probe for detection of JA.

Preferably, the NCQDs and the Co-MOF material have a mass ratio of (1-3):100.

Preferably, the cross-linking agent is tetraethyl orthosilicate (TEOS); the functional monomer and the cross-linking agent have a mass ratio of (9.46-18.92): (282-564); and

the JA template and the functional monomer have a mass ratio of (50-100) mg: (9-20) μg.

Preferably, the polymerization is conducted in the dark for 6 h to 24 h.

The present disclosure further provides a detection method of JA, including the following steps:

mixing a sample to be tested with the fluorescent probe for detection of JA, measuring fluorescence spectra of an obtained mixture under excitation at 320 nm and 378 nm, and recording fluorescence intensities at emission wavelengths of 367 nm and 442 nm, to obtain a ratio of the fluorescence intensity at 442 nm to the fluorescence intensity at 367 nm; and

obtaining a JA concentration in the sample to be tested according to a predetermined standard curve and the ratio of the fluorescence intensities; where the standard curve is a linear relationship curve between the JA concentration and the ratio of the fluorescence intensity at 442 nm to the fluorescence intensity at 367 nm.

Preferably, the JA has a linear detection range of 1 ng/mL to 800 ng/mL.

The present disclosure provides a fluorescent probe for detection of JA, including a Co-MOF material, and NCQDs and a MIP distributed on a surface of the Co-MOF material; where the MIP has an MI of the JA. In the present disclosure, a surface of the NCQD is negatively charged, and JA is also negatively charged. Simply combining the NCQDs with the JA is difficult to detect changes in a fluorescence signal of the probe by photo-induced electron transfer (PET). The NCQDs are distributed on the surface of the Co-MOF material, and cobalt ions in the Co-MOF material can undergo a coordination reaction with amino groups of the NCQDs to change a charge distribution on the surface of the NCQD; meanwhile, the Co-MOF material can also avoid aggregation of the NCQDs to improve a detection stability. By using the MIP with a JA recognition site as a target recognition target of the JA, an interaction of the NCQDs with other interfering molecules can be prevented. Under a synergistic effect of the Co-MOF material and the MIP, the JA can interact with the NCQDs through the PET, resulting in changes in the fluorescence signal of the probe, thereby realizing sensitive and specific detection of the JA.

The present disclosure further provides a preparation method of the fluorescent probe for detection of JA. In the present disclosure, an NCQDs-loaded Co-MOF material is mixed with a JA template, a functional monomer, a cross-linking agent, and an alkaline reagent, polymerization is conducted, and the JA template is removed to obtain the fluorescent probe for detection of JA. The preparation method has simple operation and low cost, which can easily achieve industrialized mass production.

The present disclosure further provides a detection method of JA. In the present disclosure, by using a linear relationship between a JA concentration and a ratio of fluorescence intensities, the JA can be quickly and sensitively detected, providing information support and reference for the early warning of crop disease stress and the rapid detection strategies of other plant hormones. The results of the examples show that in the present disclosure, the JA has a linear detection range of 1 ng/mL to 800 ng/mL.

### BRIEF DESCRIPTION OF THE DRAWINGS

FIG. 1A-C show preparation processes of NCQDs, Co-MOFs, and NCQDs@Co-MOFs@MIPs;

FIG. 2A-C show microstructures of the NCQDs, the Co-MOFs, and the NCQDs@Co-MOFs@MIPs;

FIG. 3 shows an X-ray diffraction (XRD) pattern of the NCQDs@Co-MOFs@MIPs fluorescent probe;

FIG. 4 shows a Fourier transform infrared spectroscopy (FTIR) spectrum of the NCQDs@Co-MOFs@MIPs fluorescent probe;

FIG. 5 shows an X-ray photoelectron spectroscopy (XPS) full spectrum of the NCQDs@Co-MOFs@MIPs fluorescent probe;

FIG. 6A-6C show C is (FIG. 6A), N is (FIG. 6B), and Co 2p (FIG. 6C) spectrograms of the NCQDs@Co-MOFs@MIPs fluorescent probe;

FIG. 7 shows a schematic diagram of the NCQDs@Co-MOFs@MIPs fluorescent probe for detecting JA;

FIG. 8 shows a fluorescence spectrogram of the fluorescent probe exposed to different JA concentrations under an excitation wavelength of 320 nm;

FIG. 9 shows a fluorescence spectrogram of the fluorescent probe exposed to different JA concentrations under an excitation wavelength of 378 nm;

FIG. 10 shows a standard curve of JA quantitative detection;

FIG. 11 shows a response value of the probe to potential interfering substances;

FIG. 12 shows a fluorescence output signal measured after the fluorescent probe is continuously exposed to 100 ng/mL JA for 4 h; and

FIG. 13 shows a fluorescence output signal of the fluorescent probe after storage for 0 d to 30 d.

### DETAILED DESCRIPTION OF THE EMBODIMENTS

The present disclosure provides a fluorescent probe for detection of JA, abbreviated as NCQDs@Co-MOFs@MIPs, including a Co-MOF material, and NCQDs and a MIP distributed on a surface of the Co-MOF material; where the MIP has a MI of the JA.

In the present disclosure, the Co-MOF material has an organic ligand of 2,4-dimethylimidazole. The Co-MOF material has a structural formula preferably shown in formula 1:

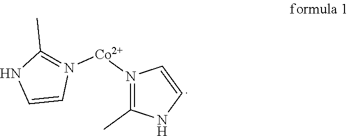

In the present disclosure, the MIP has a functional monomer of preferably APTES.

In the present invention, the Co-MOF material and the MIP have a mass ratio of preferably (1,000-6,000):1, more preferably (2000-5000):1.

In the present disclosure, the fluorescent probe for detection of JA has a particle size of preferably 100 nm to 500 nm, more preferably 200 nm to 400 nm; and the MIP has a thickness of preferably 3 nm to 20 nm, more preferably 5 nm to 15 nm, and further more preferably 10 nm.

The present disclosure further provides a preparation method of the fluorescent probe for detection of JA, including the following steps:
(1) providing the NCQDs and the Co-MOF material;
(2) mixing the NCQDs and the Co-MOF material with water to obtain an NCQDs-loaded Co-MOF material; and
(3) mixing the NCQDs-loaded Co-MOF material with a JA template, the functional monomer, a cross-linking agent, and an alkaline reagent, conducting polymerization, and removing the JA template to obtain the fluorescent probe for detection of JA.

In the present disclosure, the NCQDs and the Co-MOF material are provided.

In the present disclosure, the NCQD has a particle size of preferably 2 nm to 8 nm. There is no special requirement for a source of the NCQDs, and the NCQDs can be commercially available in the field or self-prepared. When self-preparing the NCQDs, a preparation method includes preferably the following steps:

mixing o-phenylenediamine with citric acid and an organic solvent, and conducting a hydrothermal reaction to obtain the NCQDs.

In the present disclosure, the o-phenylenediamine and the citric acid have a molar ratio of preferably 1:1 to 1:3, more preferably 1:1. The organic solvent is preferably N,N-dimethylformamide (DMF).

In the present disclosure, the mixing is preferably conducted by stirring for preferably 10 min to 30 min, more preferably 10 min to 20 min.

In the present disclosure, the hydrothermal reaction is preferably conducted in a reactor at preferably 160° C. to 200° C., more preferably 180° C. for preferably 12 h to 24 h, more preferably 18 h to 20 h.

In the present disclosure, after the hydrothermal reaction, an obtained hydrothermal reaction solution is preferably subjected to post-treatment, and the post-treatment includes preferably the following steps:

subjecting the hydrothermal reaction solution to centrifugation to obtain a supernatant; and

subjecting the supernatant to dialysis and refrigeration.

In the present disclosure, the centrifugation is conducted at preferably 9,000 rpm to 12,000 rpm for preferably 10 min to 20 min, more preferably 15 min. The dialysis is conducted at a molecular weight cut-off of preferably 10,000 Da for preferably 36 h to 72 h, more preferably 48 h to 60 h. The refrigeration is conducted at preferably 4° C.

In the present disclosure, the Co-MOF material has a particle size of preferably 100 nm to 500 nm, more preferably 200 nm to 400 nm. There is no special requirement for a source of the Co-MOF material, and the Co-MOF material can be commercially available in the field or self-prepared. When self-preparing the Co-MOF material, a preparation method preferably includes the following steps:

mixing the organic ligand, a soluble divalent cobalt source, and an organic solvent to conduct a coordination reaction to obtain the Co-MOF material.

In the present disclosure, the organic ligand is preferably 2,4-dimethylimidazole; and the soluble divalent cobalt source is preferably cobalt nitrate. The organic solvent is preferably methanol.

In the present disclosure, the organic ligand and the soluble divalent cobalt source are preferably dissolved separately in the organic solvent and then mixed. The mixing is preferably conducted by stirring for preferably 1 h to 3 h, more preferably 2 h.

In the present disclosure, the coordination reaction is conducted preferably at a room temperature and standing still. The coordination reaction is conducted for preferably 12 h to 24 h, more preferably 18 h to 20 h.

In the present disclosure, after the coordination reaction, an obtained coordination reaction solution is preferably subjected to post-treatment, and the post-treatment includes preferably the following steps:

subjecting the coordination reaction solution to solid-liquid separation, and washing and drying an obtained solid to obtain a pure Co-MOF material.

In the present disclosure, the solid-liquid separation is conducted preferably by centrifugation at preferably 8,000 rpm to 12,000 rpm for preferably 10 min to 30 min, more preferably 15 min to 20 min. The washing is conducted 2 times using a detergent of preferably ethanol and distilled water. The drying is conducted preferably in vacuum at preferably 40° C. to 60° C., more preferably 50° C. to 60° C. for preferably 12 h to 24 h.

In the present disclosure, the Co-MOF material is refrigerated at 4° C.

In the present disclosure, the NCQDs and the Co-MOF material are mixed with water to obtain an NCQDs-loaded Co-MOF material. The NCQDs and the Co-MOF material have a mass ratio of preferably (1-3):100, more preferably 2.6:100. The NCQDs are provided preferably in the form of an aqueous dispersion, and the aqueous dispersion of the NCQDs has a concentration of preferably 3 mg/mL.

In the present disclosure, the mixing is conducted by preferably stirring for preferably 10 min to 60 min, more preferably 20 min to 40 min.

In the present disclosure, the NCQDs-loaded Co-MOF material is mixed with a JA template, the functional monomer, a cross-linking agent, and an alkaline reagent, polymerization is conducted, and the JA template is removed to obtain the fluorescent probe for detection of JA. The functional monomer is preferably APTES; the cross-linking agent is preferably TEOS; and the alkaline reagent is preferably ammonia water with a concentration of preferably 25 wt %.

In the present disclosure, the cross-linking agent is preferably the TEOS; and the functional monomer and the cross-linking agent have a mass ratio of preferably (9.46-18.92):(282-564), more preferably (12-15):(300-400). The JA template and the functional monomer have a mass ratio of preferably (50-100) mg: (9-20) μg, more preferably (60-80) mg: (10-15) μg. The functional monomer and the alkaline reagent have a mass ratio of preferably (9.46-18.92):(4.5-9), more preferably 9.46:(4.5-9).

In the present disclosure, the mixing is conducted preferably as follows:

The NCQDs-loaded Co-MOF material is subjected to first mixing with the JA template and the functional monomer, and then subjected to second mixing with the cross-linking agent and the alkaline reagent. The first mixing is conducted by preferably stirring for preferably 1 h to 4 h, more preferably 2 h to 3 h; and the second mixing mode is conducted by preferably stirring.

In the present disclosure, the polymerization is conducted preferably in the dark preferably at room temperature for preferably 6 h to 24 h, more preferably 12 h to 18 h.

In the present disclosure, a method for removing the JA template includes preferably the following steps:

subjecting an obtained polymerization reaction solution to centrifugation, and washing a precipitate obtained by the centrifugation.

In the present disclosure, the centrifugation is conducted at preferably 8,000 rpm to 12,000 rpm, more preferably 10,000 rpm for preferably 10 min to 30 min, more preferably 15 min to 25 min.

In the present disclosure, the washing is conducted preferably 3 to 8 times, more preferably 4 to 5 times using a detergent of preferably methanol.

The present disclosure further provides a detection method of JA, including the following steps:

mixing a sample to be tested with the fluorescent probe for detection of JA, measuring fluorescence spectra of an obtained mixture under excitation at 320 nm and 378 nm, and recording fluorescence intensities at emission wavelengths of 367 nm and 442 nm, to obtain a ratio of the fluorescence intensity at 442 nm to the fluorescence intensity at 367 nm; and

obtaining a JA concentration in the sample to be tested according to a predetermined standard curve and the ratio of the fluorescence intensities; where the standard curve is a linear relationship curve between the JA concentration and the ratio of the fluorescence intensity at 442 nm to the fluorescence intensity at 367 nm.

In the present disclosure, the sample to be tested is preferably an organic solvent extract of an analyte. The analyte is preferably a plant, more preferably a crop, particularly preferably rice, wheat, or corn.

In the present disclosure, a preparation method of the sample to be tested includes preferably the following steps:

freezing and grinding the analyte sequentially to obtain an analyte powder; and

mixing the analyte powder with an organic solvent, and conducting standing, washing, and centrifugation in sequence to obtain the sample to be tested.

In the present disclosure, the freezing is conducted preferably in liquid nitrogen; and the grinding is conducted preferably using an abrasive, and a ground analyte powder has a particle size of preferably 100 μm to 500 μm.

In the present disclosure, the organic solvent is preferably ethyl acetate.

In the present disclosure, the standing is conducted preferably overnight. The washing is conducted using a detergent of preferably a hydrochloric acid solution, with a mass concentration of preferably 0.1% to 0.2%.

In the present disclosure, the centrifugation is conducted at preferably 8,000 rpm to 12,000 rpm for preferably 10 min to 30 min, more preferably 15 min to 20 min. Preferably, a supernatant is collected after centrifugation to obtain the sample to be tested.

In the present disclosure, a method for drawing the standard curve includes preferably the following steps:

providing a gradient of JA standard solutions of known concentrations; and

mixing the gradient of JA standard solutions of known concentrations with the fluorescent probe for detection of JA, testing fluorescence spectra of obtained mixtures under excitation at 320 nm and 378 nm, recording fluorescence intensities at emission wavelengths of 367 nm and 442 nm, to obtain a ratio of the fluorescence intensities corresponding to the gradient of JA standard solutions of known concentrations; taking the JA standard solution as an abscissa and the ratio of the fluorescence intensities as an ordinate, drawing a standard curve.

As a specific example of the present disclosure, the gradient of JA standard solutions of known concentrations, the ratio of the fluorescence intensities corresponding to the gradient of JA standard solutions of known concentrations, and the specific standard curve are shown in Table 1.

TABLE 1
Relevant data of standard curve

| | JA standard solution concentration/ng/mL | | | | | | |
|---|---|---|---|---|---|---|---|
| | 0 | 0.5 | 1 | 3 | 5 | 7 | 10 |
| I₄₄₂/I₃₆₇ | 0.353 | 0.387 | 0.417 | 0.436 | 0.458 | 0.474 | 0.495 |

| Standard curve | Y = 0.009X + 0.409 R² = 0.994 | | | | | |
|---|---|---|---|---|---|---|
| | JA standard solution concentration/ng/mL | | | | | |
| | 10 | 50 | 100 | 300 | 500 | 800 |
| I₄₄₂/I₃₆₇ | 0.495 | 0.513 | 0.531 | 0.586 | 0.665 | 0.739 |

| | |
|---|---|
| Standard curve | Y = 3.205X + 0.496 R² = 0.992 |

The fluorescent probe for detection of JA and the preparation method thereof, and the detection method of JA provided by the present disclosure are described in detail below in conjunction with the examples, but these examples should not be construed as limiting the protection scope of the present disclosure.

### Example 1

### Preparation and Characterization of a Fluorescent Nanoprobe NCQDs@Co-MOFs@MIPs:

(1) Synthesis of NCQDs: 0.5 mmol of o-phenylenediamine (OPD) and 0.5 mmol of citric acid were mixed in 10 mL of a DMF solution and stirred for 10 min. A resulting mixture was then transferred into a reactor and reacted at 180° C. for 24 h to obtain a sample of the NCQDs. The sample was centrifuged at 9,000 rpm for 10 min, and a retained supernatant was dialyzed against distilled water using a dialysis membrane for 48 h to remove impurities. The dialyzed NCQDs were stored at 4° C. until use.
(2) Preparation of Co-MOFs: 400 mg of 2,4-dimethylimidazole (MelM) and 200 mg of cobalt nitrate hexahydrate were dissolved in 10 mL of methanol separately. The above ingredients were quickly mixed and stirred for 2 h. Stirring was stopped and a resulting product was aged at a room temperature for 24 h. A product was centrifuged at 10,000 rpm for 15 min, and a collected precipitate was washed twice with ethanol and distilled water to obtain the Co-MOFs. The purified Co-MOFs were dried under vacuum at 60° C. for 12 h, and dried Co-MOFs were stored at 4° C. for later use.
(3) Preparation of a fluorescent probe: 3 mL of a prepared Co-MOFs solution (100 mg/mL) and 2.6 mL of the NCQDs were mixed and stirred for 20 min. 10 μL of APTES and 100 mg of JA were added to the above mixture and stirred for 2 h. 10 μL of ammonia water and 500 μL of TEOS were added to a resulting mixture and stirred in the dark for 12 h. A resulting product was centrifuged at 9,000 rpm for 20 min to remove excess reagents, and a collected precipitate was eluted with methanol repeatedly 5 times to remove a JA template. An obtained product was dispersed in 10 mL of distilled water to obtain the NCQDs@Co-MOFs@MIPs probe.

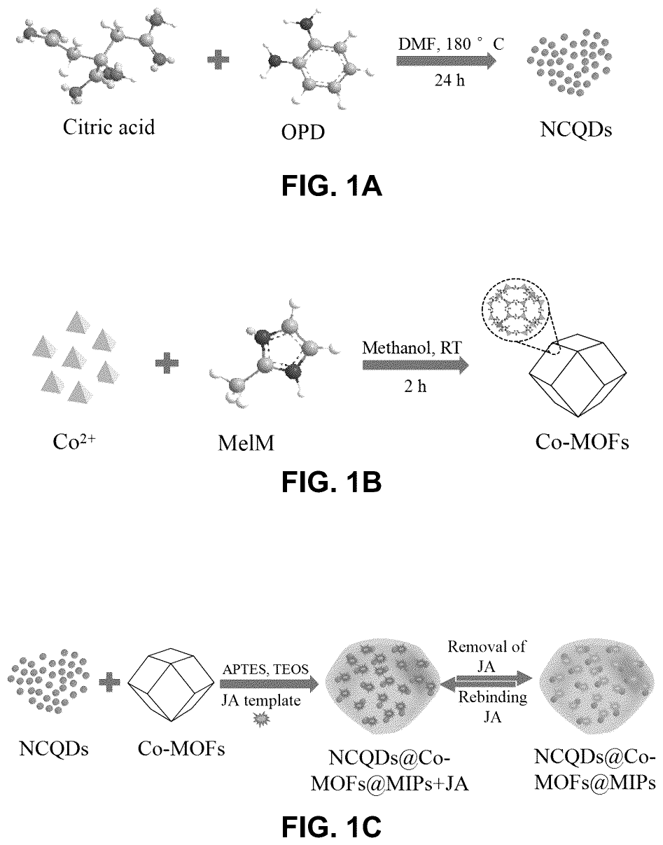

FIG. 1A-C showed preparation processes of NCQDs, Co-MOFs, and NCQDs@Co-MOFs@MIPs.

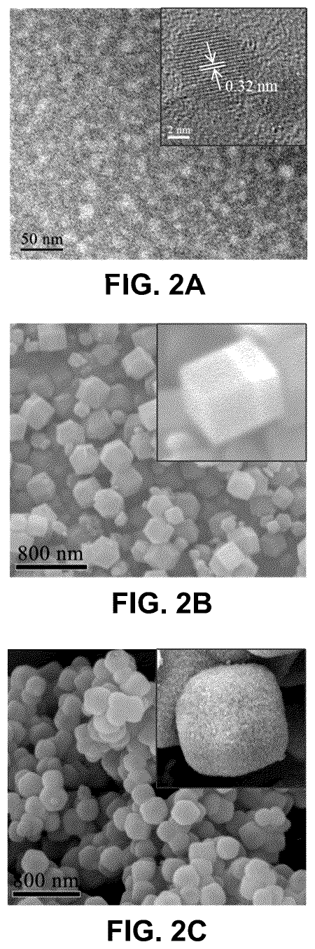

The NCQDs, Co-MOFs, and NCQDs@Co-MOFs@MIPs were examined by transmission electron microscopy (TEM) or scanning electron microscopy (SEM), and the test results of obtained microstructures were shown in FIG. 2A-C. In FIG. 2A-C, (a) was the TEM image of NCQDs, (b) was the SEM image of Co-MOF, and (c) was the SEM image of Co-MOFs@MIPs. As shown in FIG. 2A-C, the Co-MOF material had a cubic morphology, and the NCQDs and MIPs were distributed on the surface of the Co-MOF material.

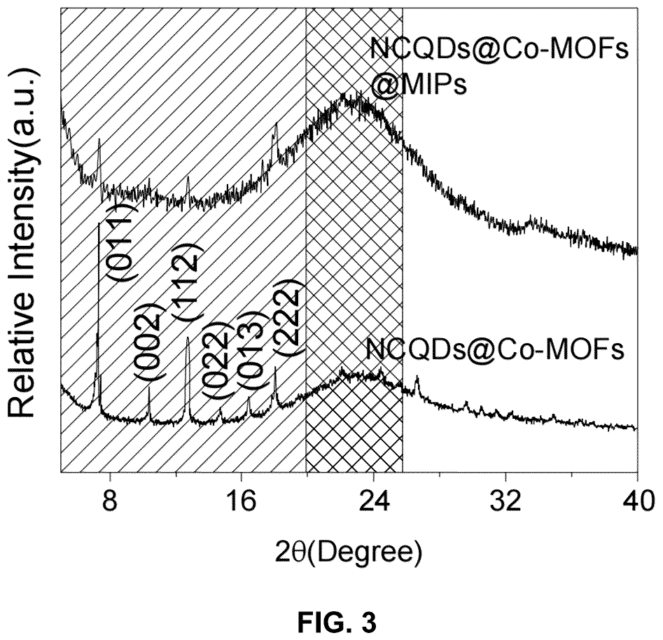

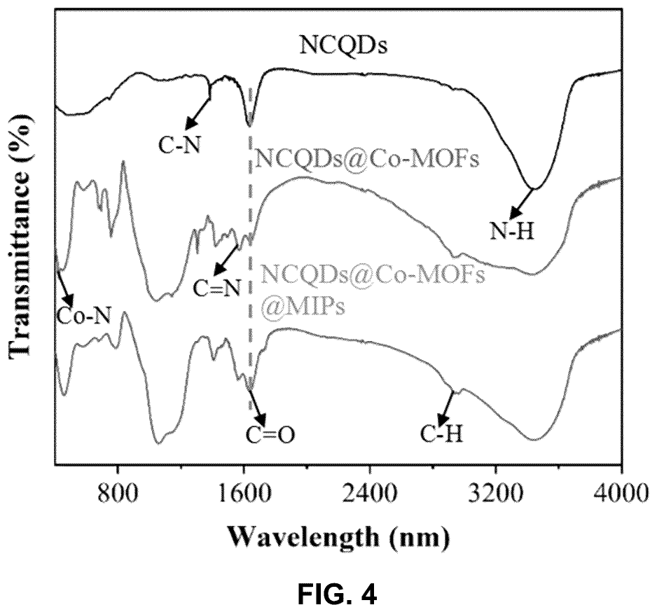

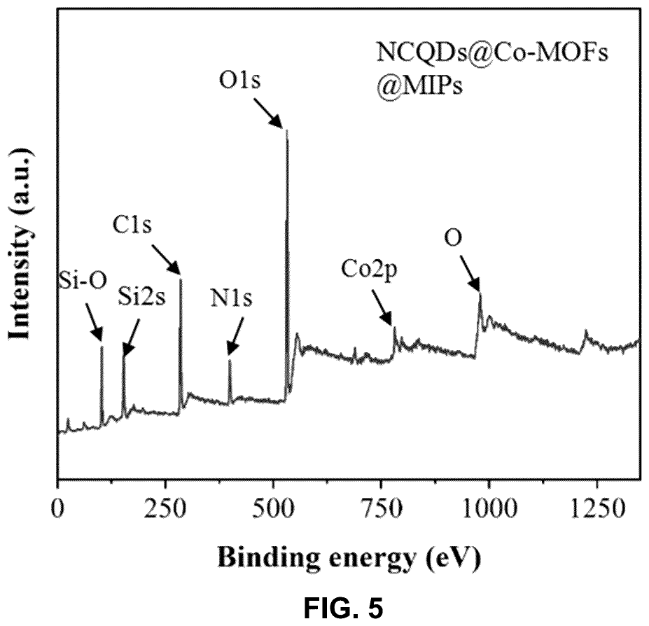

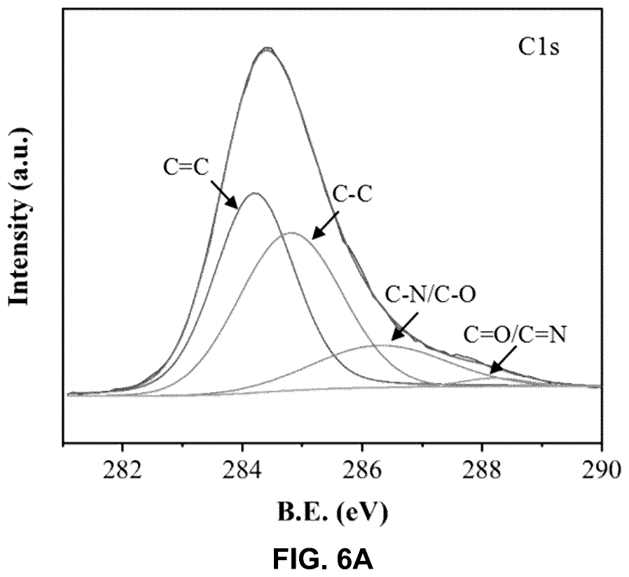

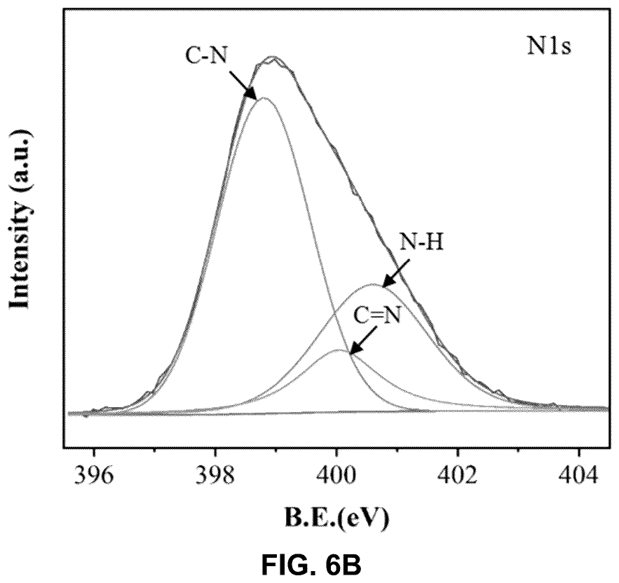

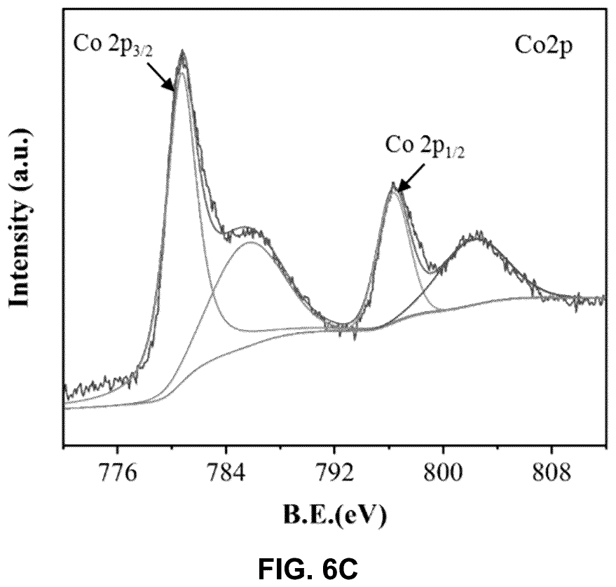

The NCQDs@Co-MOFs@MIPs fluorescent probe had an XRD pattern shown in FIG. 3, an FTIR spectrum shown in FIG. 4, an XPS full spectrum shown in FIG. 5, and C 1s, N 1s, and Co 2p spectrograms shown in FIG. 6A-6C. As shown in FIG. 4 to FIG. 6, the NCQDs, CO-MOFs, and MIP composites were successfully prepared.

### Example 2

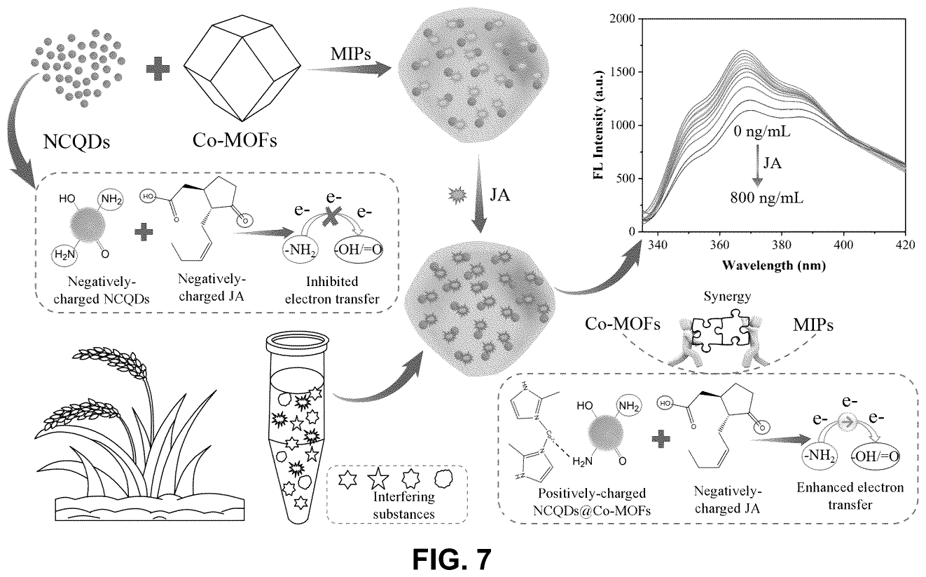

The fluorescent nanoprobe NCQDs@Co-MOFs@MIPs was used for JA detection, where a schematic diagram of the NCQDs@Co-MOFs@MIPs fluorescent probe for JA detection was shown in FIG. 7.

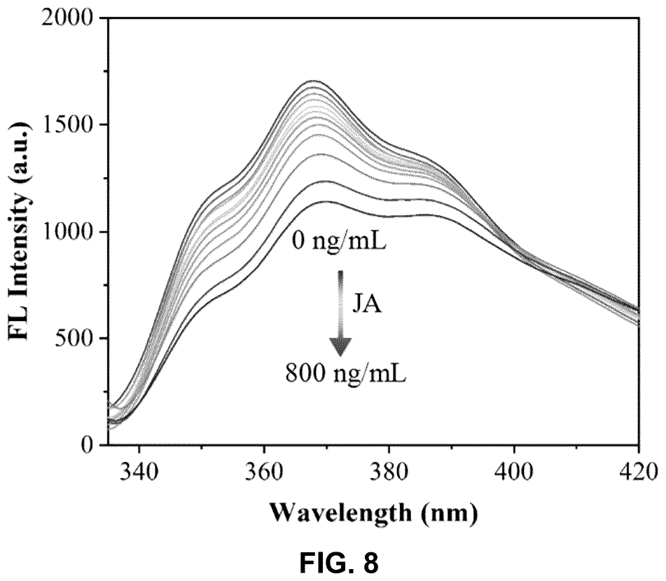

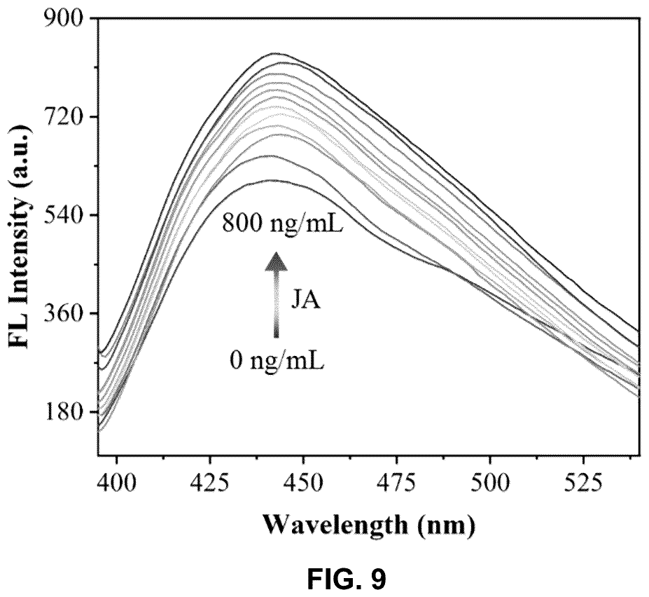

Establishment of a JA detection standard curve: 500 μL of the NCQDs@Co-MOFs@MIPs fluorescent probe was incubated with 500 μL of the JA standard solutions of different concentrations (0 ng/mL, 0.5 ng/mL, 1 ng/mL, 3 ng/mL, 5 ng/mL, 7 ng/mL, 10 ng/mL, 50 ng/mL, 100 ng/mL, 300 ng/mL , 500 ng/mL, and 800 ng/mL) for 18 min. The fluorescence spectra were measured under excitation at 320 nm and 378 nm, respectively, and the emission intensities were recorded at 367 nm and 442 nm, respectively. FIG. 8 showed a fluorescence spectrogram of the fluorescent probe exposed to different JA concentrations under the excitation wavelength of 320 nm; FIG. 9 showed a fluorescence spectrogram of the fluorescent probe exposed to different JA concentrations under the excitation wavelength of 378 nm.

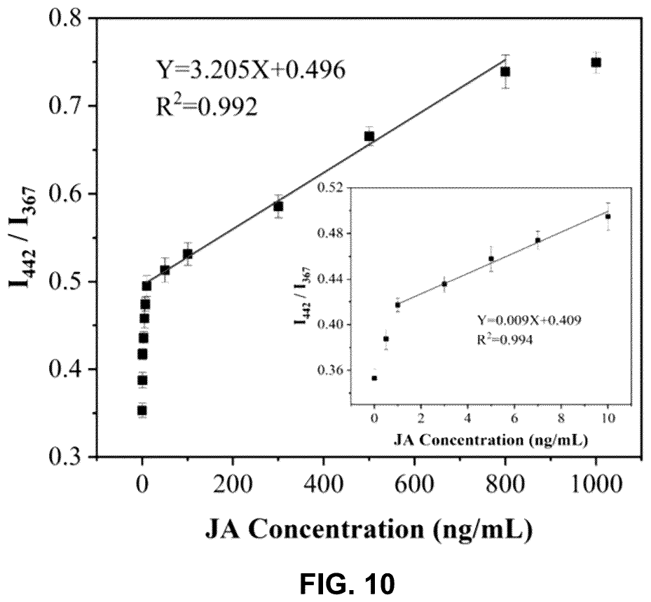

By using a ratio of the fluorescence intensities of the above peaks (1442/1367), a standard curve for the quantitative detection of JA was established, and the results were shown in FIG. 10. It was seen from FIG. 10 that the NCQDs@Co-MOFs@MIPs fluorescent probe could achieve the quantitative detection of JA at 1800 ng/mL.

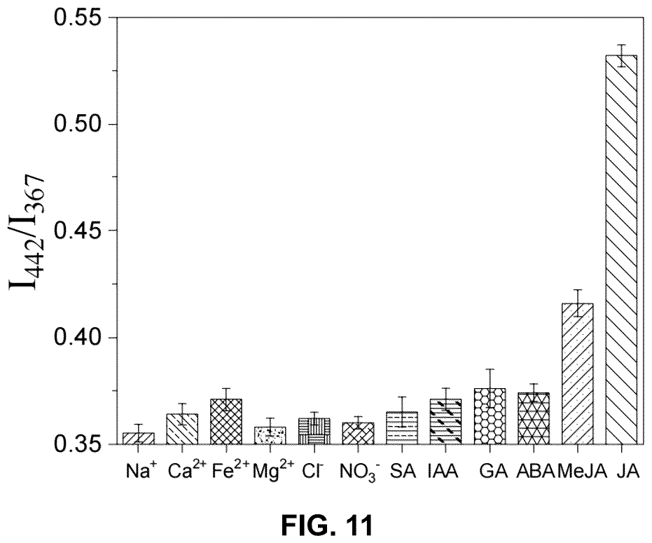

The response values of the probe to potential interfering substances were tested, and the results were shown in FIG. 11. The JA had a concentration of 100 ng/mL and the interfering substances had a concentration of 500 ng/mL. The interfering substances included Na⁺, Ca²⁺, Fe²⁺, Mg²⁺, Cl⁻, NO₃₋, salicylic acid (SA), indoleacetic acid (IAA), gibberellin (GA), abscisic acid (ABA), and methyl jasmonate (MeJA).

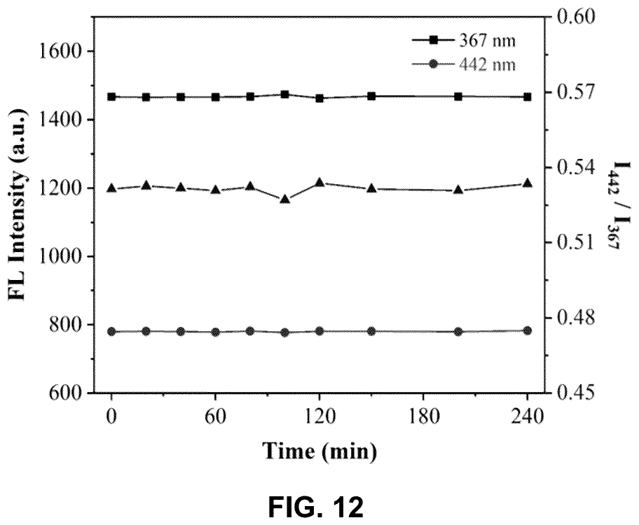

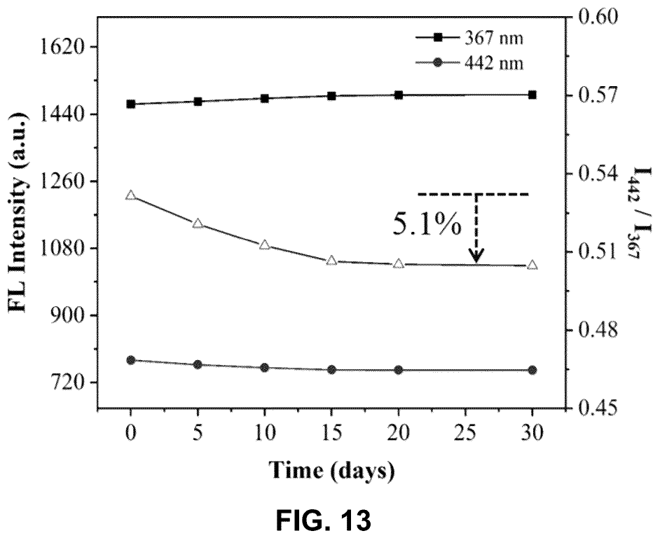

FIG. 12 showed a fluorescence output signal measured after the fluorescent probe was continuously exposed to 100 ng/mL JA for 4 h; and FIG. 13 showed a fluorescence output signal of the fluorescent probe after storage at 4° C. for 0 d to 30 d. It was seen from FIG. 12 and FIG. 13 that the NCQDs@Co-MOFs@MIPs fluorescent probe of the present disclosure had desirable stability.

### Example 3

By using the method of Example 2, the content of JA in rice seeds and seedlings was detected: rice samples were pretreated, including the steps as follows: the rice seeds or seedlings were placed in a centrifuge tube, frozen in liquid nitrogen, and grinding with a commercial grinder. 1 mL of ethyl acetate was added to the centrifuge tube and kept at 4° C. overnight. A collected supernatant was washed with 100 μL of aqueous hydrochloric acid (0.2%) and centrifuged at 12,000 rpm for 10 min. A supernatant was collected, and different concentrations of JA were added to the supernatant to form a test solution. After the sample was pretreated, quantitative detection of JA was conducted on the sample according to the method in step (1) and HPLC. Specific detection results were shown in Table 2.

TABLE 2
Test results of sample addition recovery

| | Added amount | Measured value | Recovery | RSD |
|---|---|---|---|---|
| Sample | (ng/mL) | (ng/mL) | rate (%) | (%, n = 3) |
| Rice | 0.00 | 12.62 | — | 1.25 |
| germinated | 5.00 | 18.02 | 108.00 | 3.16 |
| seeds | 50.00 | 63.96 | 102.68 | 1.85 |
| | 200.00 | 216.21 | 101.80 | 3.57 |
| Rice | 0.00 | 141.55 | — | 2.62 |
| seedling | 5.00 | 147.18 | 112.60 | 2.39 |
| leaves | 50.00 | 194.24 | 105.38 | 1.44 |
| | 200.00 | 348.76 | 103.61 | 3.83 |

As shown in Table 2, in the present disclosure, the recovery rate was 101.80% to 112.60%, indicating that the fluorescent probe could be used for accurate detection of JA content in actual crops.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A fluorescent probe for detection of jasmonic acid (JA), comprising a cobalt-based metal-organic framework (Co-MOF) material, and aminated carbon quantum dots (NCQDs) and a molecular imprinting polymer (MIP) that are distributed on a surface of the Co-MOF material; wherein the MIP has a molecular imprinting (MI) of the JA.

2. The fluorescent probe for detection of JA according to claim 1, wherein the MIP has a functional monomer of (3-aminopropyl)triethoxysilane (APTES); and
the Co-MOF material has an organic ligand of 2,4-dimethylimidazole.

3. The fluorescent probe for detection of JA according to claim 1, wherein the Co-MOF material and the MIP have a mass ratio of (1,000-6,000):1.

4. The fluorescent probe for detection of JA according to claim 2, wherein the Co-MOF material and the MEP have a mass ratio of (1,000-6,000):1.

5. The fluorescent probe for detection of JA according to claim 1, wherein the fluorescent probe for detection of JA has a particle size of 100 nm to 500 nm; and the MIP has a thickness of 3 TIM to 20 nm.

6. A preparation method of the fluorescent probe for detection of JA according to claim 1, comprising the following steps:
(1) providing the NCQDs and the Co-MOF material;
(2) mixing the NCQDs and the Co-MOF material with water to obtain an NCQDs-loaded Co-MOF material; and
(3) mixing the NCQDs-loaded Co-MOF material with a JA template, the functional monomer, a cross-linking agent, and an alkaline reagent, conducting polymerization, and removing the JA template to obtain the fluorescent probe for detection of JA.

7. The preparation method according to claim 6, wherein the MIP has a functional monomer of (3-aminopropyl)triethoxysilane (APTES); and
the Co-MOF material has an organic ligand of 2,4-dimethylimidazole.

8. The preparation method according to claim 6, wherein the Co-MOF material and the MIP have a mass ratio of (1,000-6,000):1.

9. The preparation method according to claim 7, wherein the Co-MOF material and the MIP have a mass ratio of (1,000-6,000):1.

10. The preparation method according to claim 6, wherein the fluorescent probe for detection of JA has a particle size of 100 nm to 500 nm; and the MIP has a thickness of 3 nm to 20 nm.

11. The preparation method according to claim 6, wherein the NCQDs and the Co-MOF material have a mass ratio of (1-3):100.

12. The preparation method according to claim 7, wherein the NCQDs and the Co-MOF material have a mass ratio of (1-3):1.00.

13. The preparation method according to claim 8, wherein the NCQDs and the Co-MOF material have a mass ratio of (1-3):100.

14. The preparation method according to claim 9, wherein the NCQDs and the Co-MOF material have a mass ratio of (1-3):100.

15. The preparation method according to claim 10, wherein the NCQDs and the Co-MOF material have a mass ratio of (1-3):100.

16. The preparation method according to claim 6, wherein the cross-linking agent is tetraethyl orthosilicate (TEOS); the functional monomer and the cross-linking agent have a mass ratio of (9.46-18.92):(282-564); and
the JA template and the functional monomer have a mass ratio of (50-100) mg: (9-20) μg.

17. The preparation method according to claim 7, wherein the cross-linking agent is tetraethyl orthosilicate (TEOS); the functional monomer and the cross-linking agent have a mass ratio of (9.46-18.92):(282-564); and
the JA template and the functional monomer have a mass ratio of (50-100) mg: (9-20) μg.

18. The preparation method according to claim 6, wherein the polymerization is conducted in the dark for 6 h to 24 h.

19. A detection method of JA, comprising the following steps:
mixing a sample to be tested with the fluorescent probe for detection of JA according to claim 1, measuring fluorescence spectra of an obtained mixture under excitation at 320 nm and 378 nm, and recording fluorescence intensities at emission wavelengths of 367 nm and 442 nm, to obtain a ratio of the fluorescence intensity at 442 nm to the fluorescence intensity at 367 nm; and
obtaining a JA concentration in the sample to be tested according to a predetermined standard curve and the ratio of the fluorescence intensities; wherein the standard curve is a linear relationship curve between the JA concentration and the ratio of the fluorescence intensity at 442 nm to the fluorescence intensity at 367 nm.

20. The detection method according to claim 19, wherein the JA has a linear detection range of 1 ng/mL to 800 ng/mL.
